(19) United States
(12) Patent Application Publication
(10) Pub. No.: US 2025/0200508 A1
(43) Pub. Date: Jun. 19, 2025

(54) ELECTRONIC APPARATUS, NON-TRANSITORY COMPUTER-READABLE MEDIUM AND LABEL CONVERSION METHOD FOR WAREHOUSE MANAGEMENT

(71) Applicant: WPG Holdings Co., Ltd., Taipei City (TW)

(72) Inventor: JHIH-CYUAN YOU, Taipei City (TW)

(21) Appl. No.: 18/981,225

(22) Filed: Dec. 13, 2024

Related U.S. Application Data
(60) Provisional application No. 63/610,647, filed on Dec. 15, 2023.

(51) Int. Cl. G06Q 10/087; G06F 16/25

(52) U.S. Cl. CPC G06Q 10/087; G06F 16/258

(57) ABSTRACT

An electronic apparatus defines a plurality of label-data-source columns, each of which corresponds to a data item that is from an item pool including a default item and a plurality of substitute items with different priority levels. The electronic apparatus assigns a corresponding data item for each of the label-data-source columns according to order information to generate a label-data-source format. The electronic apparatus extracts or converts first label data according to the label-data-source format to generate a label-data source. The electronic apparatus generates second label data according to the label-data source.

### PRIORITY

This application claims priority to U.S. Provisional Applications No. 63/610,647 filed on Dec. 15, 2023, the entire contents of which are incorporated herein by reference.

### FIELD

The present disclosure relates to a warehouse management technology. More specifically, the present disclosure relates to an electronic apparatus, a non-transitory computer-readable medium, and a label conversion method for warehouse management.

### BACKGROUND

Every manufacturer has its own label-data format, so when customers (buyers) receive goods from different manufacturers (sellers), they can only identify information of these goods according to the label-data formats of different manufacturers if the label-data formats of different manufacturers are not tuned, and it is difficult to store and manage the information of these goods effectively. Therefore, the traditional warehouse management system usually sets a customized label-data format for each customer, thereby converting the label-data formats of different manufacturers into a unified label-data format. However, with the increase of the number of manufacturers, the change of the label-data format by manufacturers, or the increase of the number of customers, the traditional warehouse management system will spend a large amount of resources to tune the label-data format, and thus, it is particularly important to improve the efficiency of the warehouse management system in tuning label-data formats.

### SUMMARY

In order to overcome the above problems, the present disclosure provides an electronic apparatus for warehouse management. The electronic apparatus may comprise a storage and a processor being electrically connected with the storage. The storage may be configured to store first label data. The processor may be configured to: define a plurality of label-data-source columns, each of which corresponds to a data item that is from an item pool including a default item and a plurality of substitute items with different priority levels; assign a corresponding data item for each of the label-data-source columns according to order information to generate a label-data-source format; extract or convert the first label data according to the label-data-source format to generate a label-data source; and generate second label data according to the label-data source.

In order to overcome the above problems, the present disclosure further provides a non-transitory computer-readable medium. The non-transitory computer-readable medium, after being loaded into an electronic apparatus, may cause the electronic apparatus to execute the following instructions: defining a plurality of label-data-source columns, each of which corresponds to a data item that is from an item pool including a default item and a plurality of substitute items with different priority levels; assigning a corresponding data item for each of the label-data-source columns according to order information to generate a label-data-source format; extracting or converting first label data according to the label-data-source format to generate a label-data source; and generating second label data according to the label-data source.

In order to overcome the above problems, the present disclosure further provides a label conversion method executed by an electronic apparatus. The label conversion method may comprise the following steps: defining a plurality of label-data-source columns, each of which corresponds to a data item that is from an item pool including a default item and a plurality of substitute items with different priority levels; assigning a corresponding data item for each of the label-data-source columns according to order information to generate a label-data-source format; extracting or converting first label data according to the label-data-source format to generate a label-data source; and generating second label data according to the label-data source.

In the present disclosure, each of the label-data-source columns corresponds to a default item, and according to order information (i.e., customer requirements), it is determined which label-data-source columns remain corresponding to default items and which label-data-source columns need to select substitute items with the highest priority level from item pools with the same property to replace the default items. Therefore, no matter whether the number of manufacturers increases, manufacturers change the label-data format, or the number of customers increases, the electronic apparatus, the non-transitory computer-readable medium, and the label conversion method provided according to the present disclosure only need to automatically fine-tune the label-data-source columns that need to be tuned without completely reset the label-data format for each customer. Therefore, as compared to the traditional warehouse management system, the efficiency of tuning label-data formats can be improved.

The above content provides a basic description of the present invention, including the technical problems to be solved by the present invention, the technical means adopted by the present invention and the technical effects achieved by the present invention, and various embodiments of the present invention will be further exemplified hereinafter. Additionally, as described below, the electronic apparatus, the non-transitory computer-readable medium, and the label conversion method provided according to the present disclosure also have additional technical features and technical effects in different embodiments.

### BRIEF DESCRIPTION OF THE DRAWINGS

FIG. 1 illustrates a schematic architectural diagram of an electronic apparatus for warehouse management according to some embodiments of the present invention.

FIG. 2A illustrates a schematic view of a label-data-source column and an item pool according to some embodiments of the present invention.

FIG. 2B illustrates a schematic view of how the electronic apparatus generates second label data according to some embodiments of the present invention.

FIG. 2C illustrates another schematic view of how the electronic apparatus generates second label data according to some embodiments of the present invention.

FIG. 3A illustrates a schematic view of how the electronic apparatus performs splitting processing according to some embodiments of the present invention.

FIG. 3B illustrates a schematic view of how the electronic apparatus performs consolidating processing according to some embodiments of the present invention.

FIG. 4 illustrates a schematic view of how a non-transitory computer-readable medium drives the electronic apparatus to execute instructions according to some embodiments of the present invention.

FIG. 5 illustrates a schematic view of a label conversion method according to some embodiments of the present invention.

### DETAILED DESCRIPTION

The following example embodiments are not intended to limit the claimed invention to specific environments, examples, applications, structures, processes, or scenarios. In the attached drawings, elements unrelated to the claimed invention are omitted from depiction. In the attached drawings, dimensions of and dimensional scales among individual elements are only provided as schematic exemplary examples, and are not intended to limit the claimed invention. Unless otherwise specified, the same element symbols may indicate the same elements.

Terminology described here is only for the ease of describing the content of the embodiments, and is not intended to be used to limit the claimed invention. Unless particularly and explicitly stated otherwise, the singular form “a/an” or “one” shall be regarded as including the plural form as well. Terms such as “comprising”, “including” and “having” are used to specify the presence of a feature, integer, step, operation, element, component and/or group stated after the terms, but do not exclude the presence or addition of one or more other additional features, integers, steps, operations, elements, components and/or groups. The term “and/or” is used to indicate any one or all combinations of one or more associated items listed. When used to describe elements, terms such as “first”, “second” and “third” are not intended to limit but only to distinguish these elements described. Thus, for example, a first element may also be named as a second element without departing from the spirit or scope of the claimed invention.

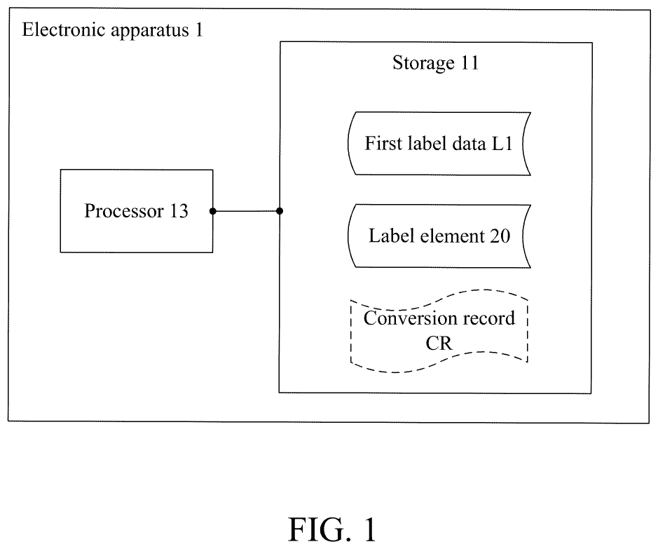

Some embodiments of the present invention relate to an electronic apparatus for warehouse management (which is referred to as “an electronic apparatus 1” hereinafter). FIG. 1 illustrates a schematic architectural diagram of an electronic apparatus 1, but the contents shown in FIG. 1 are only for exemplifying the embodiment of the present invention, and are not intended to limit the scope claimed in the present invention. The electronic apparatus 1 may be various electronic apparatuses with computer functions, such as, but not limited to, personal computers, portable computers, tablet computers, mobile apparatuses, and the like.

As shown in FIG. 1, the electronic apparatus 1 may basically comprise a storage 11 and a processor 13, and the storage 11 and the processor 13 are electrically connected (directly or indirectly) to each other. The processor 13 may be a programmable specific integrated circuit that is capable of operating, storing, outputting/inputting or the like, and it may receive and process various coded instructions, thereby performing various logical operations and arithmetical operations and outputting corresponding operation results. The processor 13 may be programmed to interpret various instructions and execute various tasks or programs to complete various actions described in the present disclosure. For example, the processor 13 may comprise a Central Processing Unit (CPU), a Digital Signal Processor (DSP), a Microprocessor, and/or a Microcontroller or the like.

The storage 11 may comprise a primary storage device (e.g., a memory) and may store the instruction set read by the processor 13. In some embodiments, in addition to the primary storage device, the storage 11 may further comprise a secondary storage device (e.g., a hard disk, an optical disk), which is connected to the processor 13 through an internal I/O channel and uses a data buffer to transmit data to the primary memory. In some embodiments, in addition to the primary storage device and the secondary storage device, the storage 11 may further comprise a tertiary storage device (e.g., a portable disk and a cloud hard disk), which may also copy data into the secondary storage device.

The storage 11 may be configured to store data generated by the electronic apparatus 1 or data transmitted from the outside to the electronic apparatus 1. For example, the storage 11 may be configured to store first label data L1, one or more label elements 20 and a conversion record CR. An external apparatus may be used to generate the first label data L1 (e.g., a barcode scanner is used to scan the barcode on the goods) and input it into the storage 11. For example, the first label data L1 may comprise the original factory label data of a certain manufacturer (comprising, for example, order numbers, customer names, part numbers of original factories, dates of production, inventory units, places of origin, moisture sensitivity levels, product versions and other information).

When receiving goods from manufacturers, warehouse personnel may first scan the case number (i.e. the mark number on the case) of the goods through a barcode scanner or a two-dimensional barcode scanner to obtain the information of the goods, and may retrieve corresponding order information (i.e., customer requirements) according to the information of the goods. Accordingly, the electronic apparatus 1 may set unified label column data first, and when the corresponding order information is retrieved, the electronic apparatus 1 may automatically generate a label-data source with a format meeting the customer requirements according to the order information, and generate label data meeting the customer requirements accordingly.

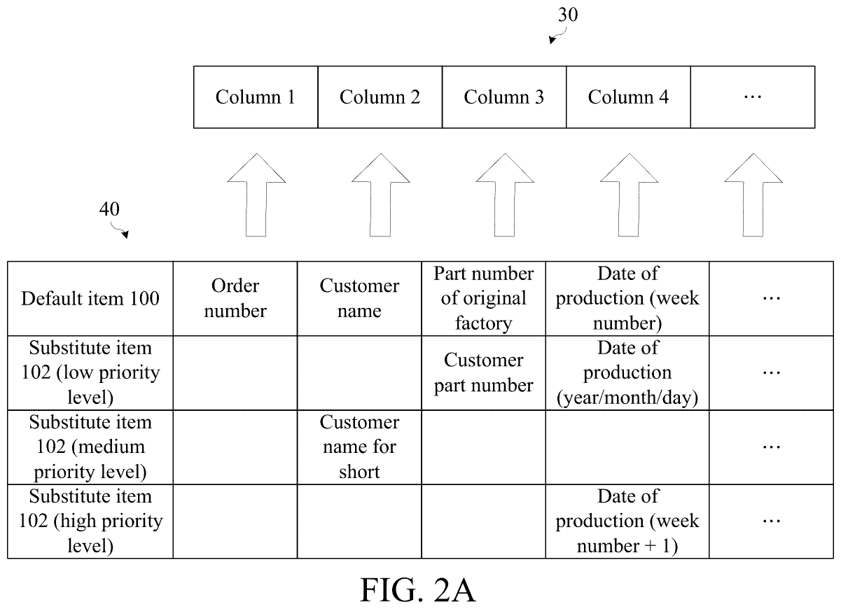

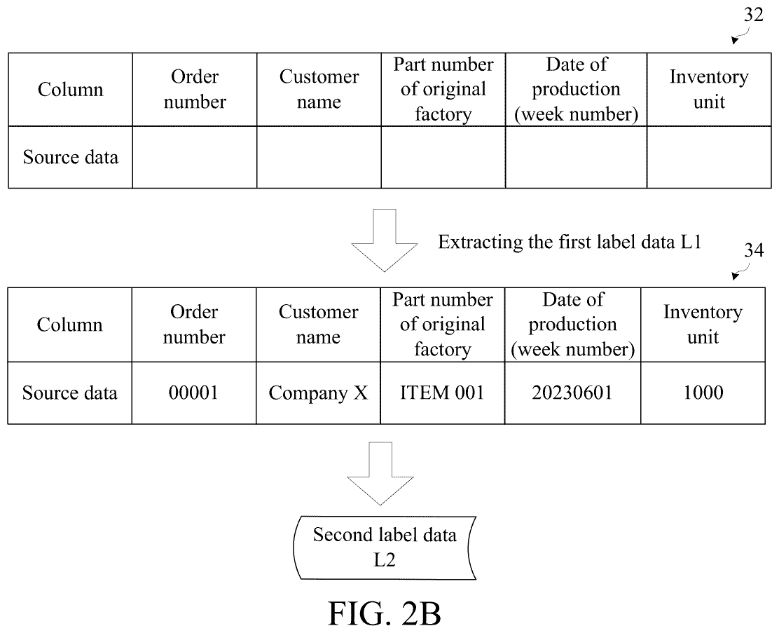

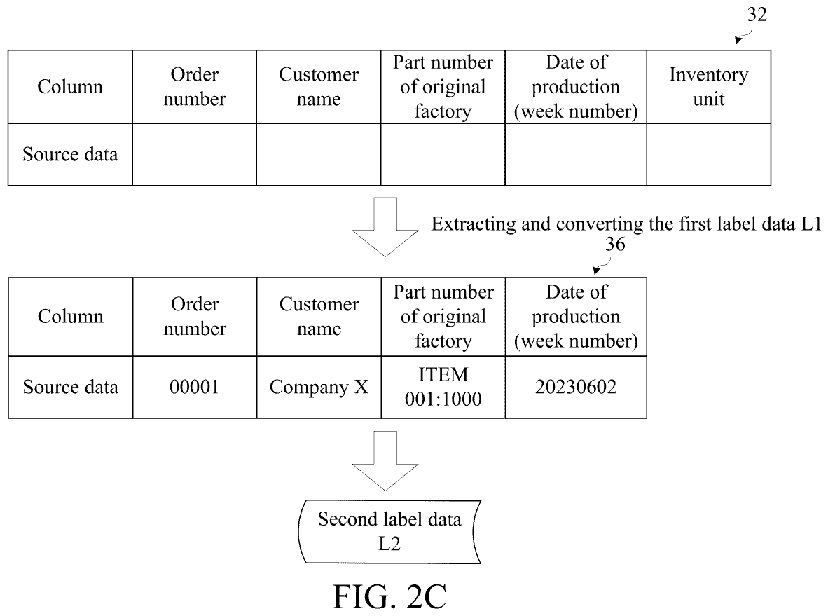

How the electronic apparatus 1 generates a label-data source will be illustrated below with reference to FIG. 2A to FIG. 2C. FIG. 2A illustrates a schematic view of a label-data-source column and an item pool according to some embodiments of the present invention. FIG. 2B illustrates a schematic view of how the electronic apparatus generates second label data according to some embodiments of the present invention. FIG. 2C illustrates another schematic view of how the electronic apparatus generates second label data according to some embodiments of the present invention. The contents shown in FIG. 2A to FIG. 2C are only for exemplifying the embodiment of the present invention, and are not intended to limit the scope claimed in the present invention.

As shown in FIG. 2A, the processor 13 may be configured to define a plurality of label-data-source columns 30, each of which corresponds to a data item, and each of the data items is from a default item pool 40. Each of the item pools 40 may include a default item 100 with a general or basic property, while according to the requirements, some of these item pools 40 may additionally include one or a plurality of substitute items 102, which belong to the same property as the default item but have different priority levels from the default item, used for substitution of the original default item 100. For example, it is assumed that the default items of label-data-source columns 1 to 4 correspond to “Order number”, “Customer name”, “Part number of the original factory” and “Date of production (week number)” respectively, the substitute item of the column 2 includes “Customer name for short” with a medium priority level, the substitute item of the column 3 includes “Part number of customer” with a low priority level, and the substitute items of the column 4 include “Date of production (year/month/day)” with a low priority level and “Date of production (week number+1)” with a high priority level. When the order information includes “Customer name for short”, “Part number of customer” and “Date of production (week number+1)”, the data items that the columns 1 to 4 finally correspond to will be “Order number”, “Customer name for short”, “Part number of customer” and “Date of production (week number+1)” respectively. In other words, according to the order information, it can be determined which label-data-source columns remain corresponding to default items and which label-data-source columns need to select substitute items with the highest priority level from item pools with the same property to replace the default items. Therefore, the processor 13 will only need to automatically fine-tune the label-data-source columns that need to be tuned instead of resetting the label-data format of each customer, so the efficiency of tuning label-data formats can be improved.

As shown in FIG. 2B, after the processor 13 defines a plurality of label-data-source columns 30, a corresponding data item for each of the label-data-source columns can be assigned according to order information to generate a label-data-source format 32. Then, the processor 13 may extract the first label data L1 according to the label-data-source format 32 to generate a label-data source 34. For example, if the processor 13 has confirmed that the data items of the columns 1 to 5 are “Order number”, “Customer name for short”, “Part number of customer”, “Date of production (week number+1)” and “Inventory unit” respectively, then the processor 13 will respectively extract corresponding label data (i.e., “00001”, “Company X”, “ITEM 001”, “20230601 (represented by 4 codes of year A.D.+2 codes of month+2 codes of week number)” and “1000”) from the first label data L1 for the columns 1 to 5, so as to generate a label-data source 34. Then, the processor 13 may generate second label data L2 used for printing customer labels according to the label-data source 34 and store it in the storage 11.

In some embodiments, for one or more label-data-source columns, the processor 13 may convert one or more pieces of label data in the first label data L1 according to one or a plurality of label elements 20 to generate corresponding source data in these label-data-source columns. The label elements 20 refer to elements with various data processing functions and operation functions, such as but not limited to, string processing functions and algorithm processing functions. Various kinds of data processing are performed on the first label data through the label elements 20 with the data processing or operation functions, which will be helpful for generating source data required by label conversion, thereby improving the capability of tuning label-data formats.

For example, if the label element 20 has a string processing function, then as shown in FIG. 2C, when a column needs to present the information of both “Part number of original factory” and “Inventory unit”, the processor 13 may use the first label element 20 to perform string superposition processing (e.g., string+colon+string processing) on corresponding label data for the columns of both “Part number of original factory” and “Inventory unit” (i.e., “ITEM 001” and “1000”) to make it into “ITEM 001:1000” and put “ITEM 001:1000” under the column of “Part number of original factory” as the source data. In addition, if the label element 20 has an algorithm processing function, then as also shown in FIG. 2C, when the week number needs to be changed, the processor 13 may use the label element 20 to perform digit addition processing (e.g., week number+1) on the corresponding label data for the column of “Date of production (week number)” (i.e., “20230601”) to make it into “20230602” as the source data. Through the above-mentioned string processing and algorithm processing, the processor 13 can generate a label-data source 36. Therefore, if one or more pieces of label data of the first label data L1 need to be substituted, then the processor 13 may convert one or more pieces of label data of the first label data L1 into a piece of source data under the respective label-data-source columns 30 through respective label elements 20.

In some embodiments, after the processor 13 generates the second label data L2, the storage 11 may remove the label element 20 to release the data storage space in the storage 11. In addition, in some embodiments, the storage 11 may store the record that the processor 13 converts the first label data L1 according to the label element 20 (i.e., the conversion record CR), which allows the processor 13 to further generate corresponding source data directly for other pieces of same label data according to the conversion record CR. Through the conversion record CR, the processor may not need to perform the same conversion by the same label element 20 every time, so the execution times of the label element can be reduced. For example, if the contents of the conversion record CR include that a certain label element 20 has consolidated the label data “ITEM 001” of “Part number of original factory” and the label data “1000” of “Inventory unit” into “ITEM 001:1000”, then when the label element 20 needs to be used again to consolidate the “Part number of original factory” and the “Inventory unit”, the corresponding source data (i.e., “ITEM 001:1000”) can be directly generated according to the conversion record CR instead of executing the label element 20 again. In addition, after the processor 13 generates the second label data L2, the storage 11 may also remove the conversion record CR to release the data storage space in the storage 11.

The unit of goods may be a case, a box or a reel, and labels may be stuck on the case, the box and/or the reel. Thus, in some embodiments, the processor 13 may perform splitting processing on the first label data L1 corresponding to a single label or perform consolidating processing on the first label data L1 corresponding to multiple labels. Accordingly, the capability of tuning label-data formats can be further improved. For example, it is assumed that goods intact (that is, the whole case/box is unopened) includes two labeling modes, i.e., “Box intact” and “Case intact”, while goods non-intact (i.e., the whole case/box is not opened) includes three labeling modes, i.e., “Single original factory label”, “Multi-label for one reel” and “Multi-reel for one box”. In this case, the processor 13 can assign the labeling mode to be adopted according to the packaging mode of these goods, and can calculate the required number of labels. If the labeling mode of box intact or case intact is adopted, then it means that these goods information correspond to data items with the same property, and thus, the number of labels that can be split into can be calculated through packaging settings. If the labeling mode of multi-label for one reel or multi-reel for one box is adopted, then it means that these goods information may correspond to data items with different properties, and thus, individual labels in each reel or each box can be consolidated.

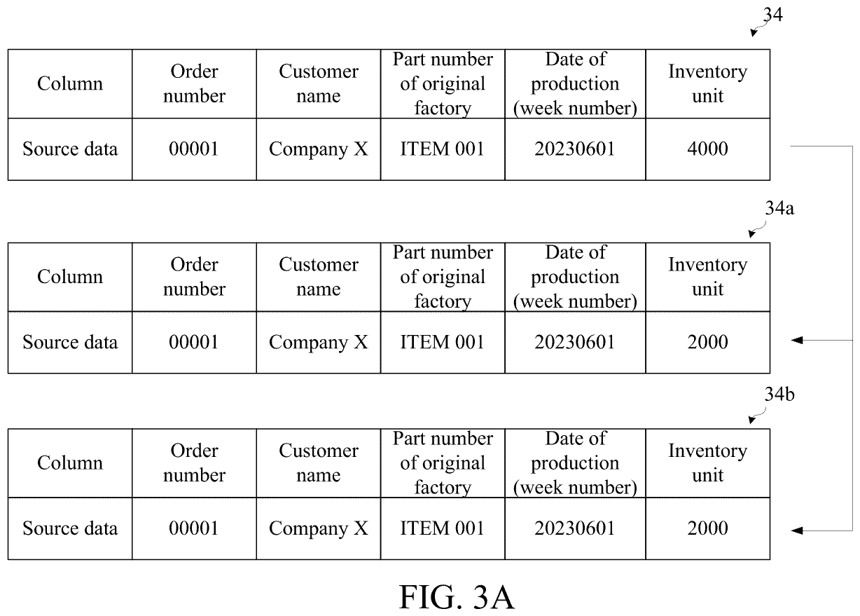

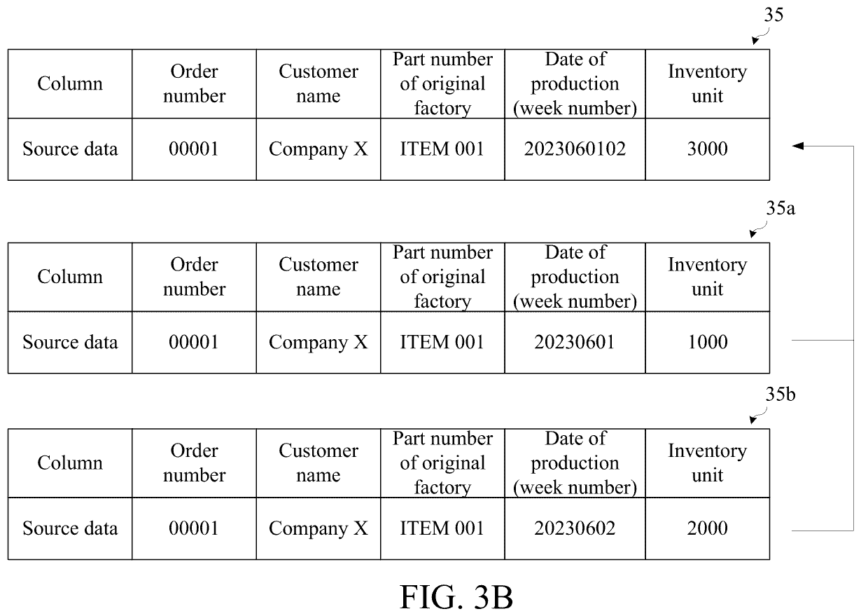

Therefore, in some embodiments, the processor 13 may perform splitting processing and/or consolidating processing on the source data corresponding to the same data item in the label-data source 34 to generate the corresponding second label data L2 according to the required number of labels. FIG. 3A illustrates a schematic view of how the electronic apparatus performs splitting process according to some embodiments of the present invention, and FIG. 3B illustrates a schematic view of how the electronic apparatus performs consolidating processing according to some embodiments of the present invention. The contents shown in FIG. 3A to FIG. 3B are only for exemplifying the embodiment of the present invention, and are not intended to limit the scope claimed in the present invention.

As shown in FIG. 3A, if the processor 13 adopts the labeling mode of box intact, then splitting processing may be performed on the label-data source 34 with an inventory unit of “4000”, for example, the label-data source 34 may be split into a label-data source 34a and a label-data source 34b each with an inventory unit of “2000”. Then as shown in FIG. 3B, if the processor 13 adopts the labeling mode of multi-label for one reel, then a label-data source 35a and a label-data source 35b may be consolidated into a label-data source 35, and the inventory unit “1000” in the label-data source 35a and the inventory unit “2000” in the label-data source 35b are added into “3000”, and the date of production “20230601” in the label-data source 35a and the date of production “20230602” in the label-data source 35b are consolidated into “2023060102”.

In some embodiments, the processor 13 may set a customer label serial number according to the second label data L2. For example, the customer label serial number may consist of a string, a date and a swift code. The string may be a customer-specified string or a default string. The date may be the date of production, such as a combination of digits expressed in “Year/Month+Week number” or “Year/Month/Day”. The swift code may be a set of non-duplicated numbers calculated by the processor 13 according to the second label data L2, such as 1 to 1000, or 0 to 9999. It is helpful for the client system to store and manage the label data by setting the customized customer label serial number.

In some cases, the processor 13 may change the date in the second label data L2 through a date conversion program 50 in a database, and set the changed date as the date in the customer label serial number. For example, the date conversion program 50 may convert the date of production from a combination of digits expressed in year/month+week number to a combination of digits expressed in year/month/day, or vice versa. In addition, the processor 13 may set a swift code in the customer label serial number through a swift code setting rule 60, including but not limited to the number of digits of the swift code (e.g., 5 digits), the carry mode of the swift code (e.g., decimal, hexadecimal), the resetting frequency (e.g., 1 day), etc.

For example, the processor 13 may convert the date “20230601 (expressed in 4 codes of year A.D.+2 codes of week number)” in the second label data L2 into “20230607 (expressed in 4 codes of year A.D.+2 codes of month+2 codes of date)” according to the date conversion program 50, and set the current swift code according to the swift code setting rule 60 (for example, 5 digits, decimal, and resetting at a frequency of 1 day), and then combine the default string “WPG”, the date “20230607” and the swift code “00001” into “WPG2023060700001” as the customized customer label serial number.

In other embodiments, after the processor 13 generates a customer label serial number, the storage 11 may store the customer label serial number. In this way, when generating other customer label serial numbers, the processor 13 can check whether there is a duplicate customer label serial number according to the record of the storage 11, and make corresponding treatments immediately. For example, the string in the customer label serial number is changed or a different swift code is set.

In addition, in some embodiments, the processor 13 may make different labels of a same customer share a set of swift codes (without duplication) according to the requirement of the customer. In other words, the processor 13 may also set swift codes in the customer label serial numbers corresponding to different label formats according to a swift code sharing rule. By sharing the same set of swift codes, it will be helpful for the client system of the same customer to store and manage the label data.

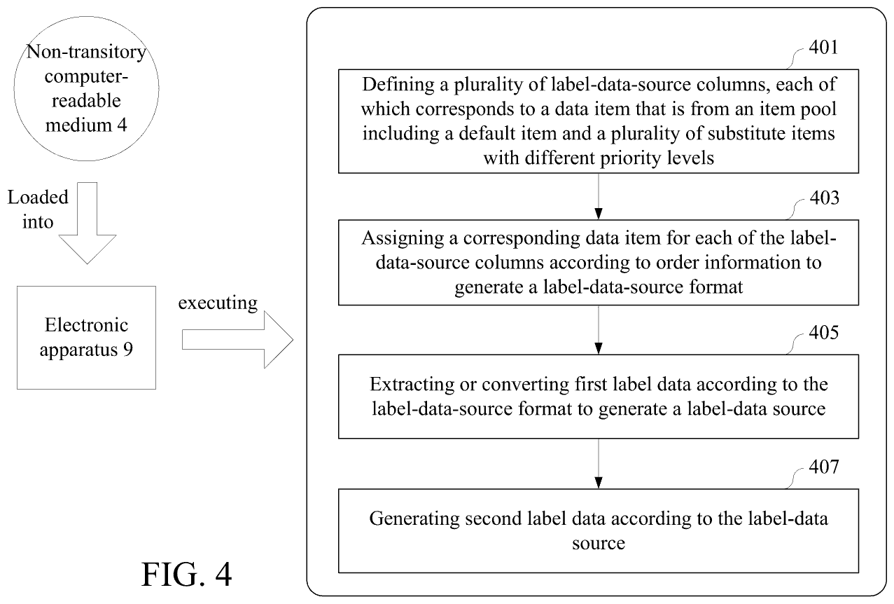

Some embodiments of the present invention relate to a non-transitory computer-readable medium (which is referred to as a “non-transitory computer-readable medium 4” hereinafter). FIG. 4 illustrates a schematic diagram illustrating how the non-transitory computer-readable medium 4 drives an electronic apparatus 9 to execute instructions, but the contents shown in FIG. 4 are only for exemplifying the embodiment of the present invention, and are not intended to limit the scope claimed in the present invention.

Referring to FIG. 4, the non-transitory computer-readable medium 4, after being loaded into an electronic apparatus, may cause the electronic apparatus 9 to execute the following instructions: defining a plurality of label-data-source columns, each of which corresponds to a data item that is from an item pool including a default item and a plurality of substitute items with different priority levels (marked as instruction 401); assigning a corresponding data item for each of the label-data-source columns according to order information to generate a label-data-source format (marked as instruction 403); extracting or converting the first label data according to the label-data-source format to generate a label-data source (marked as instruction 405); and generating second label data according to the label-data source (marked as instruction 407). In some embodiments of the non-transitory computer-readable medium 4, the electronic apparatus 9 may be the electronic apparatus 1 described above.

The non-transitory computer-readable medium 4 may be a tangible object carrying a computer-readable program, for example, a non-transitory tangible machine-readable medium. The non-transitory tangible machine-readable medium may include: a non-transitory tangible machine-readable medium, a read-only memory (ROM), a flash memory, a floppy disk, a mobile hard disk, a magnetic tape, a network database, a cloud node or other tangible objects. In some embodiments, the non-transitory computer-readable medium 4 may also be a computer program product, and the computer program product refers to an object carrying computer-readable programs and not limited to external forms, which is loaded by the electronic apparatus through various network transmissions.

In some embodiments of the non-transitory computer-readable medium 4, the electronic apparatus 9 may also be caused to execute the following instructions: storing a label element in a storage; converting one or more pieces of label data of the first label data into a piece of source data under a label-data-source column through the label element; and removing the label element from the storage after the second label data is generated. By performing various kinds of data processing on the first label data through label elements with data processing functions or operation functions, it will be helpful to generate source data required by label conversion, thereby improving the capability of tuning label-data formats. For example, the label element may have a string processing function and/or an algorithm processing function.

In these embodiments, optionally, the non-transitory computer-readable medium 4 may also cause the electronic apparatus 9 to execute the following instructions: storing a conversion record of the label element in the storage, and directly generating corresponding source data for other pieces of same label data according to the conversion record. With the conversion record, the processor may not need to perform the same conversion every time by the same label element, so that the execution times of the label element are reduced.

In some embodiments of the non-transitory computer-readable medium 4, the electronic apparatus 9 may also be caused to execute the following instruction: performing splitting processing and/or consolidating processing on the label-data source according to a labeling mode to generate the second label data. Accordingly, the capability of tuning label-data formats can be further improved.

In some embodiments of the non-transitory computer-readable medium 4, the electronic apparatus 9 may also be caused to execute the following instruction: setting a customer label serial number according to the second label data, wherein the customer label serial number consists of a string, a date and a swift code. By setting a customized customer label serial number, it will be helpful for the client system to store and manage label data. In these embodiments, optionally, the non-transitory computer-readable medium 4 may also cause the electronic apparatus 9 to execute the following instruction: setting the swift code according to a swift code sharing rule. By sharing a set of swift codes without duplication, it will be helpful for the client system to store and manage the label data.

Each embodiment of the non-transitory computer-readable medium 4 substantially corresponds to at least one embodiment of the electronic apparatus 1. Therefore, all the corresponding embodiments of the non-transitory computer-readable medium 4 can be fully appreciated by those of ordinary skill in the art simply with reference to the above description of the electronic apparatus 1, even though not all the embodiments of the non-transitory computer-readable medium 4 are described in detail above.

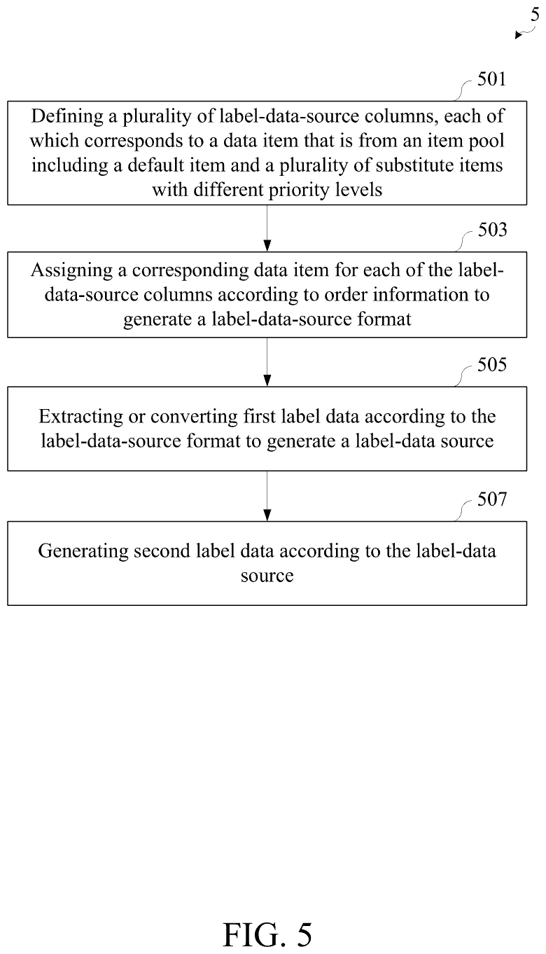

Some embodiments of the present invention relate to a label conversion method (which is referred to as a “label conversion method 5” hereinafter) executed by an electronic apparatus. FIG. 5 illustrates a schematic view of a label conversion method 5, but the contents shown in FIG. 5 are only for exemplifying the embodiment of the present invention, and are not intended to limit the scope claimed in the present invention.

As shown in FIG. 5, the label conversion method 5 may comprise the following steps: defining a plurality of label-data-source columns, each of which corresponds to a data item that is from an item pool including a default item and a plurality of substitute items with different priority levels (marked as step 501); assigning a corresponding data item for each of the label-data-source columns according to order information to generate a label-data-source format (marked as step 503); extracting or converting first label data according to the label-data-source format to generate a label-data source (marked as step 505); and generating second label data according to the label-data source (marked as step 507).

In some embodiments of the label conversion method 5, the method may further comprise: storing a label element in a storage; converting one or more pieces of label data of the first label data into a piece of source data under a label-data-source column by a label element; and removing the label element from the storage after the second label data is generated. By performing various kinds of data processing on the first label data through label elements with data processing functions or operation functions, it will be helpful to generate source data required by label conversion, thereby improving the capability of tuning label-data formats. For example, the label element may have a string processing function and/or an algorithm processing function.

In some embodiments of the label conversion method 5, the method may further comprise: storing a conversion record of the label element in the storage, and directly generating corresponding source data for other pieces of same label data according to the conversion record. With the conversion record, the processor may not need to perform the same conversion every time by the same label element, so that the execution times of the label element are reduced.

In some embodiments of the label conversion method 5, the method may further comprise: performing splitting processing and/or consolidating processing on the label-data source according to a labeling mode to generate the second label data. Accordingly, the capability of tuning label-data formats can be further improved.

In some embodiments of the label conversion method 5, the method may further comprise: setting a customer label serial number according to the second label data, wherein the customer label serial number consists of a string, a date and a swift code. By setting the customized customer label serial number, it will be helpful for the client system to store and manage label data. In these embodiments, optionally, the label conversion method 5 may further comprise: setting the swift code according to a swift code sharing rule. By sharing a set of swift numbers without duplication, it will be helpful for the client system to store and manage label data.

Each embodiment of the label conversion method 5 substantially corresponds to at least one embodiment of the electronic apparatus 1. Therefore, all the corresponding embodiments of the label conversion method 5 can be fully appreciated by those of ordinary skill in the art simply with reference to the above description of the electronic apparatus 1, even though not all the embodiments of the label conversion method 5 are described in detail above.

The above embodiments are only examples for illustrating the present invention, and are not intended to limit the scope claimed in the present invention. Any other embodiments produced by modifying, changing, adjusting and integrating the above-mentioned embodiments shall all be included in the scope claimed in the present invention as long as they are not difficult for those of ordinary skill in the art to contemplate. The scope claimed in the present invention shall be governed by the claims.

What is claimed is:

1. An electronic apparatus for warehouse management, comprising:
a storage, being configured to store first label data; and
a processor, being electrically connected with the storage and being configured to:
define a plurality of label-data-source columns, each of which corresponds to a data item that is from an item pool including a default item and a plurality of substitute items with different priority levels;
assign a corresponding data item for each of the label-data-source columns according to order information to generate a label-data-source format;
extract or convert the first label data according to the label-data-source format to generate a label-data source; and
generate second label data according to the label-data source.

2. The electronic apparatus according to claim 1, wherein:
the storage is further configured to store a label element and remove the label element after the processor generates the second label data; and
the processor is further configured to convert one or more pieces of label data of the first label data into a piece of source data under a label-data-source column through the label element.

3. The electronic apparatus according to claim 2, wherein the label element has a string processing function and/or an algorithm processing function.

4. The electronic apparatus according to claim 2, wherein the storage is further configured to store a conversion record of the label element, and the processor is further configured to directly generate corresponding source data for other pieces of same label data according to the conversion record.

5. The electronic apparatus according to claim 1, wherein the processor is further configured to: perform splitting processing and/or consolidating processing on the label-data source according to a labeling mode to generate the second label data.

6. The electronic apparatus according to claim 1, wherein the processor is further configured to: set a customer label serial number according to the second label data, wherein the customer label serial number consists of a string, a date and a swift code.

7. The electronic apparatus according to claim 6, wherein the processor is further configured to: set the swift code according to a swift code sharing rule.

8. A non-transitory computer-readable medium, after being loaded into an electronic apparatus, causing the electronic apparatus to execute the following instructions, comprising:
defining a plurality of label-data-source columns, each of which corresponds to a data item that is from an item pool including a default item and a plurality of substitute items with different priority levels;
assigning a corresponding data item for each of the label-data-source columns according to order information to generate a label-data-source format;
extracting or converting first label data according to the label-data-source format to generate a label-data source; and
generating second label data according to the label-data source.

9. The non-transitory computer-readable medium according to claim 8, further comprising causing the electronic apparatus to execute the following instructions:
storing a label element in a storage;
converting one or more pieces of label data of the first label data into a piece of source data under a label-data-source column by a label element; and
removing the label element from the storage after the second label data is generated.

10. The non-transitory computer-readable medium according to claim 9, wherein the label element has a string processing function and/or an algorithm processing function.

11. The non-transitory computer-readable medium according to claim 9, further comprising causing the electronic apparatus to execute the following instructions:
storing a conversion record of the label element in the storage, and directly generating corresponding source data for other pieces of same label data according to the conversion record.

12. The non-transitory computer-readable medium according to claim 8, further comprising causing the electronic apparatus to execute the following instruction:
performing splitting processing and/or consolidating processing on the label-data source according to a labeling mode to generate the second label data.

13. The non-transitory computer-readable medium according to claim 8, further comprising causing the electronic apparatus to execute the following instruction:
setting a customer label serial number according to the second label data, wherein the customer label serial number consists of a string, a date and a swift code.

14. The non-transitory computer-readable medium according to claim 13, further comprising causing the electronic apparatus to execute the following instruction:
setting the swift code according to a swift code sharing rule.

15. A label conversion method executed by an electronic apparatus, the method comprising:
defining a plurality of label-data-source columns, each of which corresponds to a data item that is from an item pool including a default item and a plurality of substitute items with different priority levels;
assigning a corresponding data item for each of the label-data-source columns according to order information to generate a label-data-source format;
extracting or converting first label data according to the label-data-source format to generate a label-data source; and
generating second label data according to the label-data source.

16. The label conversion method according to claim 15, further comprising:
storing a label element in a storage;
converting one or more pieces of label data of the first label data into a piece of source data under a label-data-source column by a label element; and
removing the label element from the storage after the second label data is generated.

17. The label conversion method according to claim 16, wherein the label element has a string processing function and/or an algorithm processing function.

18. The label conversion method according to claim 16, further comprising:
storing a conversion record of the label element in the storage, and directly generating corresponding source data for other pieces of same label data according to the conversion record.

19. The label conversion method according to claim 15, further comprising:
performing splitting processing and/or consolidating processing on the label-data source according to a labeling mode to generate the second label data.

20. The label conversion method according to claim 15, further comprising:
setting a customer label serial number according to the second label data, wherein the customer label serial number consists of a string, a date and a swift code.

21. The label conversion method according to claim 20, further comprising: setting the swift code according to a swift code sharing rule.
